(19) United States
(12) Patent Application Publication
(10) Pub. No.: US 2014/0019946 A1
(43) Pub. Date: Jan. 16, 2014

(54) LAYERED DECOMPOSITION FOR SCALABLE STATIC DATA RACE DETECTION OF CONCURRENT PROGRAMS

(71) Applicant: NEC Laboratories America, Inc., (US)

(72) Inventors: Kostoula Papakonstantinou, Princeton, NJ (US); Gogul Balakrishnan, Princeton, NJ (US); Aarti Gupta, Princeton, NJ (US); Vineet Kahlon, Princeton, NJ (US); Hiroki Ikeda, Tokyo (JP); Mitsuyuki Ohashi, Tokyo (JP)

(73) Assignee: NEC LABORATORIES AMERICA, INC., Princeton, NJ (US)

(21) Appl. No.: 13/836,219

(22) Filed: Mar. 15, 2013

Related U.S. Application Data
(60) Provisional application No. 61/611,219, filed on Mar. 15, 2012.

(51) Int. Cl. G06F 11/36

(52) U.S. Cl. CPC G06F 11/362
USPC 717/132

(57) ABSTRACT

Disclosed is a method of performing static data race detection in concurrent programs wherein a control flow graph (CFG) is decomposed into layers of bounded call-depth which are then used to perform a resulting analysis. Next, a set of pointers of interest are segmented into classes such that each pointer may only be aliased to pointers within its own class, these classes related to computation of shared variables, locksets, waitsets, and notifysets. A flow sensitive context sensitive points-to-analysis for program statements that impact aliases of members within the given class is performed—advantageously reducing the overall size of the problem at hand. Notably, the analysis for individual threads is performed independently of one another, on multiple layers of the CFG, and subsequently merging the results from the individual layers.

### CROSS REFERENCE TO RELATED APPLICATIONS

This application claims the benefit of U.S. Provisional Patent Application Ser. No. 61/611,219 filed Mar. 15, 2012 for all purposes as if set forth at length herein.

### TECHNICAL FIELD

This disclosure relates generally to the field of computer software and in particular to a precise and scalable static data race detection technique for debugging large, multi-threaded computer software programs.

### BACKGROUND

The widespread use of concurrent software programs in contemporary computing systems has necessitated the development of debugging methodologies for multi-threaded concurrent software. Concurrent software programs however are behaviorally complex and involve subtle interactions between multiple threads which make them particularly difficult to analyze and debug.

One type of error in a concurrent software program that is notoriously difficult to catch by contemporary methods involves data race violations. A data race occurs when two different threads in a given software program can simultaneously access a shared variable, with at least one of the accesses being a write operation. Those skilled in the art will readily appreciate that the presence of data race conditions in a concurrent software program oftentimes renders its behavior non-deterministic thereby rendering bug detection difficult.

### SUMMARY

An advance in the art is made according to an aspect of the present disclosure directed to a layered program decomposition method for static data race detection in concurrent programs.

According to an aspect of the present disclosure, a method of performing static data race detection in concurrent programs a control flow graph (CFG) is decomposed into layers of bounded call-depth which are then used to perform the resulting analysis. Next, a set of pointers of interest are segmented into classes such that each pointer may only be aliased to pointers within its own class. Finally, a points-to-analysis for program statements that impact aliases of members within the given class is performed—advantageously reducing the overall size of the problem at hand. Notably, the analysis for individual threads is performed independently of one another.

In sharp contrast to the prior art methods according to the present disclosure employ a layered decomposition approach which—instead of carrying out an analysis on a monolithic control flow graph (CFG), decompose the CFG into layers of depth at most d and carry out the analysis on these individual layers. Advantageously, and in an exemplary embodiment, file I/O is used to pass data between the different layers thereby avoiding the necessity of storing it in memory. The order in which the analysis on the individual layers is performed mimics the depth first traversal over the CFG of the threads. By limiting the size of the CFG maintained in memory we advantageously limit memory usage thereby avoiding bottlenecks in the scalability of points-to-analysis.

Of particular advantage, methods according to the present disclosure operate to locate bugs within large, industrial size concurrent programs.

### BRIEF DESCRIPTION OF THE DRAWING

A more complete understanding of the present disclosure may be realized by reference to the accompanying drawing in which:

FIG. 1 depicts a generic architecture for practicing Interference Analysis according to aspects of the present disclosure;

FIG. 2 is a flow diagram that depicts a shared variable detection procedure according to an aspect of the present disclosure; and

FIG. 3 is a flow diagram that depicts a lockset determination procedure according to an aspect of the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

Thus, for example, it will be appreciated by those skilled in the art that the diagrams herein represent conceptual views of illustrative structures embodying the principles of the disclosure.

By way of some additional background, we begin by noting that classical approaches to static race detection generally involves at least three steps (see, e.g., D. Engler and K. Ashcraft. RacerX: Effective, Static Detection of Race Conditions and Deadlocks. In SOSP, 2003; P. Pratikakis, J. S. Foster, and M. Hicks. LOCKSMITH: Context-Sensitive Correlation Analysis for Race Detection. In PLDI, 2006; S. Savage, M. Burrows, G. Nelson, P. Sobalvarro, and T. Anderson. Eraser: A dynamic data race detector for multithreaded programming. In ACM TCS, volume 15(4), 1997; and V. Kahlon, Y. Yang, S. Sankaranarayanan, and A. Gupta, Fast and Accurate Static Data-Race Detection for Concurrent Programs, CAV 2006).

The first (and arguably the most critical) step is the automatic discovery of shared variables, i.e., variables that may be accessed by two or more threads. Control locations where these shared variables are read or written determine potential locations where data races can arise. Next, locksets are computed at each location where a shared variable is accessed. Finally, each pair of locations where the same shared variable is accessed and disjoint locksets are held is determined to constitute a data race warning.

One notable drawback of static data race detection is that too many erroneous (bogus) warnings are generated that do not correspond to true bugs. As is known, the number of bogus warnings may be reduced via the use of a precise flow and context sensitive points-to analysis. However, such an analysis makes static race detection much less scalable. The use of modularization for scaling static data race detection has been explored (See, e.g., J. W. Voung, R.Jhala, and S.Lerner, RELAY: Static Race Detection on Millions of Lines of Code, ESEC/SIGSOFT FSE 2007). However, such techniques described compute function summaries for capturing aliasing information. In order to ensure scalability, precision is sacrificed in that function summaries capture only updates to a constrained set of pointers, e.g., lock pointers while shared variable detection is carried out via flow insensitive procedures thereby increasing the bogus warning rate.

With this additional background in place, a more complete discussion of a method and techniques according to the present disclosure is provided in the Appendix A to this Description.

As noted previously, methods according to the present disclosure perform shared variable discovery employing a layered control flow graph. More specifically—for each thread entry function—methods according to the present disclosure will perform an alias analysis to determine the shared variable accesses in the thread associated with that function. In accordance with a hybrid alias computation strategy both a flow insensitive as well as a flow and context sensitive analysis is leveraged to compute the desired points-to sets based on the required level of precision.

While performing the layering according to an aspect of the present disclosure, given a cutoff depth d, the CFG of the given thread is sliced laterally in strips of call-depth at most d. Then, instead of performing the analysis on a monolithic CFG, it is performed on strips of the CFG of call-depth at most d while retaining auxiliary information to stitch up the analysis results for the individual strips of the CFG.

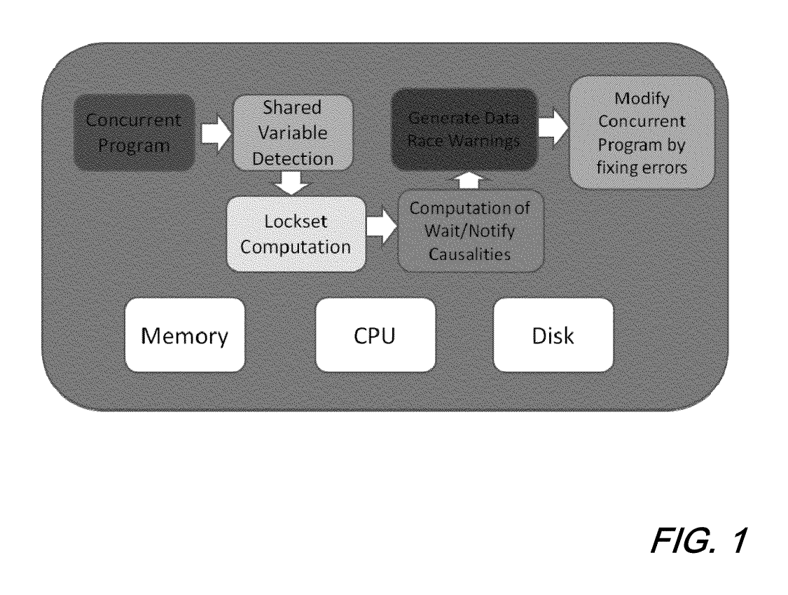

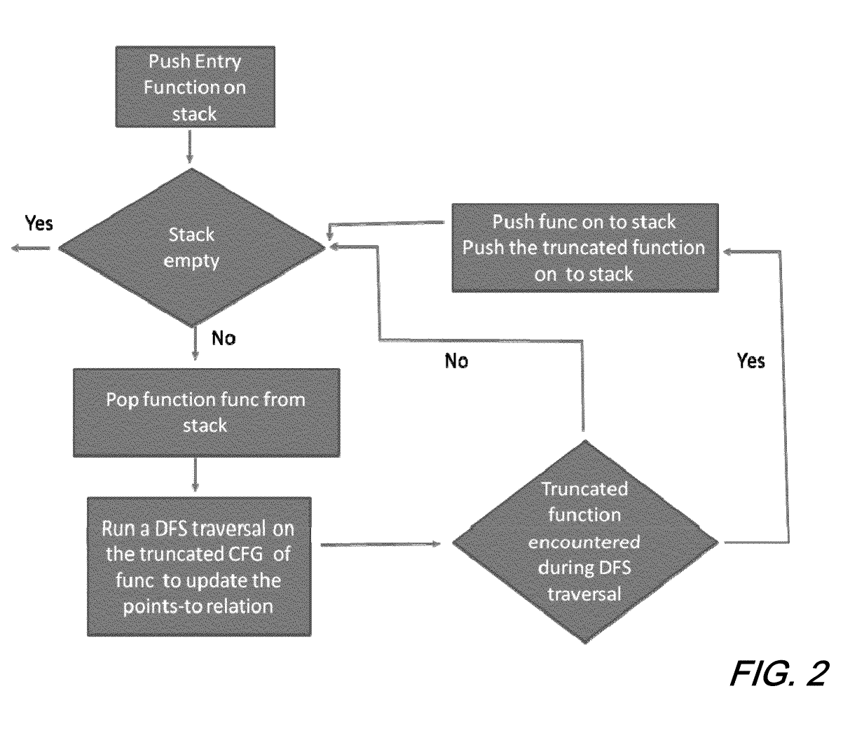

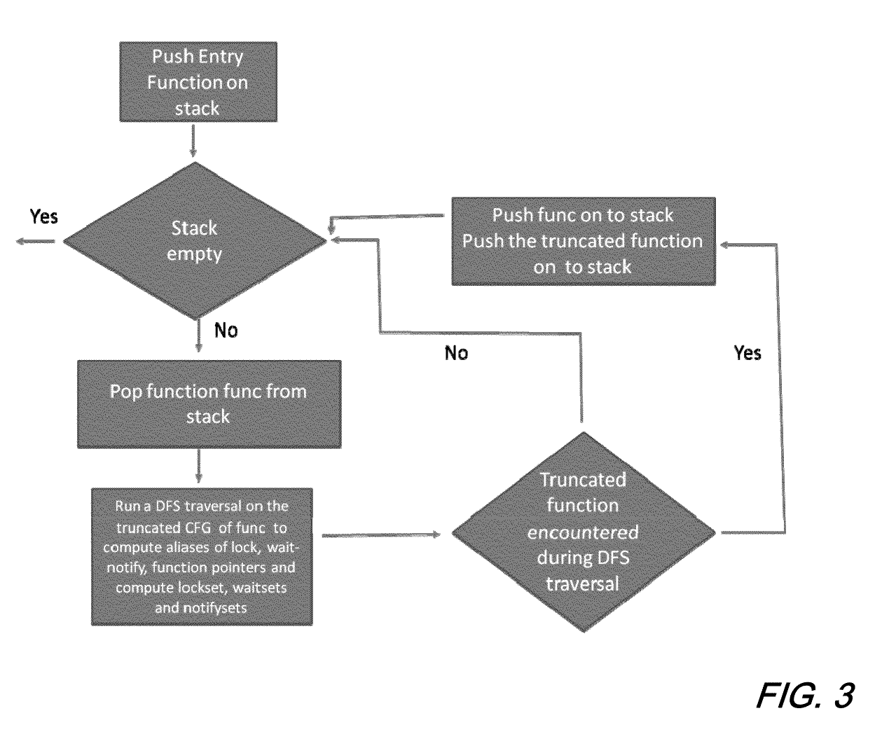

With reference to FIG. 1, there is shown a generic architecture for practicing Interference Analysis according to aspects of the present disclosure. More specifically, on a computer system including CPU, Memory, and I/O which may advantageously include Disk systems, a concurrent software program is analyzed. Operationally, shared variables are determined, locksets are computed along with causalities associated with wait/notify events and data race conditions and subsequent warnings are produced. With such information, the concurrent software program may be modified to fix any noted errors. Details of shared variable detection and lockset computation are shown schematically in flow diagrams depicted in FIG. 2 and FIG. 3, respectively.

At this point, the foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. As previously noted, additional information is provided in Appendix A to this Description. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method of performing layered program decomposition for detection of static data race conditions within concurrent software programs comprising multiple threads, said method comprising the computer implemented steps of:
constructing a control flow graph (CFG) of the concurrent software program wherein the CFG is decomposed into layers of bounded call-depth; and
using the layers of bounded call-depth for
determining shared variables using points-to analysis;
determining locksets at locations where shared variables are accessed using points-to sets for lock pointers; and
generating warnings based on disjointness of locksets.

2. The method of claim 1 further comprising using a flow insensitive points-to analysis for each thread in the current program by conducting multiple flow insensitive points-to analysis on the layers of the CFG having a maximum depth of d, and subsequently merging the results from these multiple analysis over the individual layers.

3. The method of claim 1 further comprising conducting a flow and context sensitive points-to analysis for each thread in the concurrent program by conducting multiple flow insensitive points-to analysis for individual classes of points-to sets on the layers of the CFG having a maximum depth of d, and subsequently merging the results from the individual layers.

4. The method of claim 1 wherein a context sensitive lockset, waitset and notifyset computation is conducted for each thread in the concurrent program by conducting multiple flow insensitive points-to analysis on the layers of the CFG having a maximum depth of d and merging the results from these analysis over the individual layers.

5. The method of claim 1 wherein warnings are generated based on disjointness of locksets and considering synchronization corresponding to waitsets and notifysets.

6. The method of claim 1, wherein shared variable detection and lockset computation is performed separately for each entry function in a thread.

7. The method of claim 6, wherein computations for different entry functions are performed in parallel.

8. A system for performing layered program decomposition for detection of static data race conditions within concurrent software programs comprising multiple threads, said system including a processor and a memory coupled to said processor said memory having stored thereon computer executable instructions that upon execution by the processor cause the system to:
construct a control flow graph (CFG) of the concurrent software program wherein the CFG is decomposed into layers of bounded call-depth; and
using the layers of bounded call-depth to
determine shared variables using points-to analysis;
determine locksets at locations where shared variables are accessed using points-to sets for lock pointers; and
generate warnings based on disjointness of locksets.

9. The system of claim 8 wherein the computer executable instructions upon execution by the processor further cause the system to:
perform a flow insensitive points-to analysis for each thread in the current program by conducting multiple flow insensitive points-to analysis on the layers of the CFG having a maximum depth of d, and subsequently merging the results from these multiple analysis over the individual layers.

10. The system of claim 8 wherein the computer executable instructions upon execution by the processor further cause the system to:
perform a flow and context sensitive points-to analysis for each thread in the concurrent program by performing multiple flow insensitive points-to analysis for individual classes of points-to sets on the layers of the CFG having a maximum depth of d, and subsequently merging the results from the individual layers.

11. The system of claim 8 wherein the computer executable instructions upon execution by the processor further cause the system to
perform context sensitive lockset, waitset, and notifyset computations for each thread in the concurrent program by conducting multiple flow insensitive points-to analysis on the layers of the CFG having a maximum depth of d, and merging the results from these analysis over the individual layers.

12. The system of claim 8 wherein the computer executable instructions upon execution by the processor further cause the system to
generate warnings based on disjointness of locksets while considering synchronization corresponding to waitsets and notifysets.

13. The system of claim 8 wherein the computer executable instructions upon execution by the processor further cause the system to:
perform shared variable detection and lockset computation separately for each entry function in a thread.

14. The system of claim 8 wherein the computer executable instructions upon execution by the processor further cause the system to:
perform in parallel computations for different entry functions.
